(19) United States
(12) Patent Application Publication
(10) Pub. No.: US 2013/0095323 A1
(43) Pub. Date: Apr. 18, 2013

(54) Method of producing inorganic layered double hydroxides, novel inorganic layered double hydroxides and uses of the same

(71) Applicants: Andriy Grafov, Helsinki (FI); Markku Leskelä, Helsinki (FI); Iryna Grafova, Vantaa (FI)

(72) Inventors: Andriy Grafov, Helsinki (FI); Markku Leskelä, Helsinki (FI); Iryna Grafova, Vantaa (FI)

(73) Assignee: LICENTIA OY, Helsinki (FI)

(21) Appl. No.: 13/582,465

(22) PCT Filed: Mar. 7, 2011
(86) PCT No.: PCT/FI2011/050198

§ 371 Date: Jan. 2, 2013

(30) Foreign Application Priority Data
Mar. 5, 2010 (FI) 20105223

(51) Int. Cl. B01J 6/00

(52) U.S. Cl. CPC B01J 6/00; B82Y 40/00
USPC 428/402.24; 264/642; 977/840

(57) ABSTRACT

Novel nanosized layered double hydroxide materials and a method of producing the same as well as uses of said material. The novel materials are uniform and have the general formula I

[M²⁺₁₋ₓM³⁺ₓ(OH)₂][Aⁿ⁻_{x/n}.zH₂O] I
wherein
   M²⁺ is selected from Mg²⁺, Ca²⁺, Mn²⁺, Fe²⁺, Co²⁺, Ni²⁺, and Zn²⁺
   M³⁺ is selected from Al³⁺, V³⁺, Cr³⁺, Fe³⁺, Co³⁺, Sc³⁺, Ga³⁺, and Y³⁺,
   Aⁿ⁻ stands for an anion,
   x stands for a value in the range from 0.2 to 0.33,
   n is an integer from 1 to 4 and
   z is an integer from 1 to 10.

The particle size is less than 1 μm. The material can be used in heterogeneous catalysis in organic chemistry and petrochemistry, magnetic materials, pharmaceutical applications, electrode materials, tissue engineering, cosmetics, and dietary supplements.

### BACKGROUND OF THE INVENTION

1. Field of the Invention

The present invention deals with inorganic layered double hydroxides (LDHs) or hydrotalcite-like synthetic anionic clays. In particular, the invention relates to a reagent-free method of their preparation as nanoscale particles as well as to the novel products and uses thereof.

2. Description of Related Art

In recent years, exfoliation or delamination of layered materials, i.e. fragmentation of the materials into single (or only a few) layers (nanosheets), has attracted increasing attention due to the valuable properties of the materials obtained and potential applications as inorganic components for design and obtaining of inorganic and hybrid inorgano-organic nanocomposite materials. The materials in question may have a variety of applications, such as: heterogeneous and tandem catalysts, precursors for nanomagnets, biocompatible and biodegradable materials, dietary supplements, drugs and/or controlled drug release agents, electrochemical sensors, packaging materials, advanced selective adsorbents, deodorants, fire retardants, etc.

Naturally occurring hydrous aluminium mineral phyllosilicates (cationic smectite-type mineral clays including montmorillonites, bentonites, vermiculites and saponites are widely known for their capability to undergo spontaneous exfoliation in water. However their composition and functional properties vary in a quite broad range owing to compositional non-homogeneity and structural non-uniformity of naturally occurring clay minerals. Moreover, natural clays have to be thoroughly grinded and sieved (screened) prior to use, in order to obtain microcrystalline or nanoshaped inorganic components.

Synthetic LDHs are characterised by uniformity of their structure and composition. At the same time, they are very close analogues of natural anionic clay minerals, which are extremely rare in nature. The LDHs are easily obtainable both in laboratory and industrial scale. Hydrotalcite-like materials have found a variety of applications as ion-exchangers capable to work under extreme conditions (temperature, radiation), heterogeneous catalysts, fire retardants, polymer stabilisers, and precursors of functional materials. The LDHs of Mg, Zn and Al possess full biocompatibility and biodegradability proven by the FDA several decades ago. They have been used as antacids and anti-pepsins in humans and animals.

Preparation of highly exfoliated nanosized LDHs made of single or only a few layers (nanosheets) is often a great challenge, attracting much interest due to the possibility of designing new functional nanocomposite materials. Thus JP Patent Application No. 20070311898 discloses “peeling” (i.e., exfoliation) of an LDH having inorganic anions as an intermediate layer and obtaining of a double hydroxide nanosheets thereby. The method comprises a process wherein the LDH is mixed with an aprotic polar organic solvent, such as formamide, dimethylsulfoxide, and dimethyl formamide.

The aprotic highly polar organic solvents used in the known method are very effective complexing agents. They react with the double hydroxide layers giving rise to corresponding coordination compounds, hence they modify the LDH material. Only that modified material may be obtained according to the disclosed process. The nanoparticles obtained are not stable in water and not suitable for uses in water-containing media (e.g. biomedical, cosmetic, nutritional, water treatment, diagnostics, etc). Any protic solvent will destroy and coagulate the above suspension.

Furthermore, the solvents mentioned in JP 20070311898 are toxic substances (both for living organisms and environment) or, at best (in case of dimethylsulfoxide) are harmful for the environment.

International Published Patent Application WO2007147881 discloses preparation of uniform nano-sized solid materials by continuous precipitation. The known method dwells on classic coprecipitation method. The distinctive feature of this method is the reaction apparatus. By using a flow reactor with short residence time, the particle growth is controlled. However, this technology can only be realised in micro-scale. The technology is characterised by all drawbacks of the classical co-precipitation: use of highly alkaline, toxic and environmentally harmful reagents; consequently, a multi-step resource- and energy-consuming purification should be applied to the LDH before any use. Those purification and separation methods will be particularly complicated due to nanoscale size of the LDH particles.

JP Patent Application No. 2008214128 deals with reversible delamination of the LDH intercalated with magnesium phenoxyacetate in polar solvents. This known method is similar to the one discussed above in connection with JP20070311898. Additionally, the delamination is only achieved using preliminary intercalation (i.e. modification) of the starting LDH with a bulky anion, phenoxyacetate.

Published US Patent Application Specification No. 2005238569 discloses preparation and self-assembly of nanobinary and ternary metal oxy/hydroxides with high surface area and 1-10 nm size by aerogel procedure. Such a method consist of homogenisation of metal organic precursors in organic solvent (hydrocarbons: viz. toluene), controlled hydrolysis, gelation, hydrothermal autoclave treatment, an supercritical drying of the solvent.

The known technical solution relates to synthesis (preparation) of the material, rather then to its exfoliation. The above method involves a use of highly toxic and inflammable organometallic precursors and hydrocarbon solvents. Realisation of the technology is additionally complicated by a requirement to treat the organometallic-water mixture in an autoclave at high temperatures and pressures. Moreover, the inventors does not provide any evidence that support a composition and structure of the materials obtained: elemental analysis, XRD, spectra, particle size, etc, are missing. Thus, the described technology does not give rise to layered double hydroxides.

It is known in the art [Dimotakis et al., Inorg. Chem. 29 (13), 1990, pp. 2394-2394] to prepare intercalated and pillared LDH phases from previously prepared LDH in a hydroxide anion form by classical ion-exchange reaction. As evidenced by the experimental results of this art, the authors failed to obtain the acid-substituted form of the LDH. Instead, a mixture of products and phases was received. Further, the material in question is composed of micron-sized crystals, and not nanosized reflecting the fact that ion exchange will not provide nanoparticles if the starting material is micron-sized, it merely exchanges one ion for another ion within the same particle.

For the sake of completeness it can be noted that in some earlier publications (WO2008083563 A1, EP1935441A1, WO2006129893, WO2004014982 A2, and WO9935185 A1) preparation of nanocomposite materials or drug delivery devices are discussed, wherein spacers, i.e. ions that intercalate the LDH structure in order to enhance the distance between layers, in order to permit the LDH-polymer or LDH-drug interaction, are used at preliminary steps of the nanocomposites preparation.

As evident, there is a problem in the art that exfoliation of hydrotalcite-like synthetic anionic clays (LDHs) is partially realised through chemical treatment of the bulk precursor material with reagents containing long-chain organic anions, typically surfactants, particularly dodecylsulfates. The use of long chain counter-anions atone leads to a considerable enhancement of interlayer distance in the LDH, however it is not enough to enable a separation of those layers. Modified material needs to be subjected to further treatments: either by refluxing in bulky organic solvent (like butanol or higher alcohols), or by a treatment with highly polar solvent (like formamide).

Another approach consists in intercalation of the initial LDHs with anions of different organic oxyacids or aminoacids, like lactate or glycinate, followed either by treatment with organic solvent (chloroform, formamide) or by further intercalation of the modified material with zwitterionic substances (like p-aminobenzoate). Lactate and glycinate forms of the LDH are able to exfoliate reversibly in aqueous dispersion.

All above mentioned cases are based on chemical treatment that sometimes includes several step procedures. Consequently, final exfoliated material always contain huge amounts of the ionic species used for preliminary intercalation, residual solvents used for delamination, or both. The materials obtained according to the procedures described in the prior art have to be used “as they are”, it is not possible to provide them with additional functional properties upon necessity (e.g. by adsorption of or intercalation with catalytically, pharmaceutically, or other functionally active species).

There is another problem in that a majority of the known methods stumbles on a difficulty to maintain the obtained exfoliated LDHs in that state for a tong time. Several publications report only a reversible exfoliation. High charge density in brucite-like M-O layers of the LDHs, their high affinity to form ionic and hydrogen bonds with the dispersion media stimulates easy reaggregation of layers into a bulk material. The exfoliated structures were stabilised e.g. by intercalation of acrylic monomers at 70° C. with subsequent formation of solid LDH-polymer nanocomposite.

A further problem is that action of long-chain organic surfactants, zwitterions, or other bulky anions, which are considered classic exfoliating agents for several decades, is based on substitution of small interlayer anions. Such a substitution leads to enhancement of the interlayer distance to the critical values, when the interlayer hydrogen attraction bonds brake, and the layered material undergoes a transformation into colloid state. However, this transformation is connected to an irreversible modification of the LDH particle surface, since surfactant ions, amino- or oxyacid residues, high-polar complexing organic solvents, etc. agents are strongly bonded to the brucite-like M-O layers. Such bonding or complexation result in irreversible blocking of the particles active centres, consequently in a considerable loss of activity, exchange capacity, effective surface area, etc. Quite often, the authors report theoretical values for the exchange capacity and effective surface area, whereas real (measurable) values of those parameters are significantly lower.

There are also further problems in that several above mentioned processes are based on exfoliation of the modified LDH in formamide. It is a direct straightforward method producing quite stable colloidal solutions. However, highly polar and readily complexing formamide molecules are strongly bonded to the exfoliated particles. This fact, as well as impossibility of complete elimination of toxic formamide from the gels, restrict considerably the application of the above materials in, for example, catalysis, pharmacy, cosmetics and food industry.

### SUMMARY OF THE INVENTION

It is an aim of the present invention to eliminate at least a part of the problems related to the known technology and to provide a new inorganic layered double hydroxides (LDHs) or hydrotalcite-like synthetic anionic clays and reagent-free method of their preparation as nanoscale particles.

The inventors have developed a novel method for obtaining of highly functional nano-scaled LDHs through reagent-free exfoliation (sometimes also called delamination) procedure, which enables to obtain stable nanodispersions or gels without chemical modification of the LDH precursor by using surfactant or other bulky ions that totally or partially block the active centres of the materials and reducing their effective surface and functional properties.

The method according to the invention of producing uniform nanosized layered double hydroxide materials typically comprises the steps dispersing a dehydrated and decarbonated layered double hydroxide in a moderately polar organic dispersion medium to form a suspension, reconstituting the layered double hydroxide by addition of water or aqueous solution containing required anions to the above suspension, and allowing the reconstitution to proceed for a sufficient period of time to allow for the formation of particles of a uniform nanosized layered double hydroxide material.

The present invention gives rise to uniform nanosized native LDHs (i.e. in their OH⁻ form the materials do not contain harmful organic or inorganic impurities, they may be converted in any required functional form that bears catalytically, pharmaceutically, or other functionally active species.

In particular the novel materials comprise nanosized layered double hydroxide material which are uniform. These materials have the general formula I

[M²⁺₁₋ₓM³⁺ₓ(OH)₂][Aⁿ⁻_{z/n}.zH₂O] I
wherein
   M²⁺ is selected from Mg²⁺, Ca²⁺, Mn²⁺, Fe²⁺, Co²⁺, Ni²⁺, and Zn²⁺
   M³⁺ is selected from Al³⁺, V³⁺, Cr³⁺, Fe³⁺, Co³⁺, Sc³⁺, Ga³⁺, and Y³⁺,
   Aⁿ⁻ stands for an anion,
   x stands for a value in the range from 0.2 to 0.33,
   n is an integer from 1 to 4 and
   z is an integer from 1 to 10.

The average particle size is less than 1 μm.

A number of uses are devised for the new products.

More specifically, the method according to the invention is mainly characterized by what is stated in the characterizing part of claim 1.

The present hydroxide materials are mainly characterized by what is stated in the characterizing part of claim 16.

The uses of the novel materials are characterized by what is stated in claims 21 to 30.

Considerable advantages are obtained by the invention. Thus, the invention creates a universal reagent-free method for obtaining of uniform nanosized layered double hydroxides in their most active hydroxide form. The invention enables obtaining of the nanosized LDHs in any required form that may contain anions or neutral molecules necessary for catalytic, magnetic, pharmaceutical, cosmetic, etc. applications.

The invention provides simple and atom-efficient methodology of the LDH gel stabilisation via use of biocompatible polyols: glycerol and PEGs. These dispersion media does not react with the M-O layers of the nanoparticles from one hand; from the other hand, glycerol and PEG molecules are reach enough in donor oxygen atoms that are necessary and sufficient to provide efficient separation of charged layers, and to prevent their reaggregation.

Further, the LDH nanoparticles are obtained in the most reactive form bearing any required component (if applicable and necessary). In such a way, practically all active centres on the particle's surface will be accessible for the required functional applications.

The disclosed method is by-product free, inexpensive, and does not involve any environmentally and biologically incompatible and non-degradable reagents. A dispersion of calcined LDH in glycerol or PEG dispersion media has practically unlimited shelf life without rehydration in a simple capped bottle. The LDH nanoparticles may be obtained by hydration upon necessity.

The present invention is focused on synthesis of nanoscaled LDH that may contain a large number of different kinds of ions, including pharmaceutical ingredients and drugs. A principal advantage of the method under invention consists in the high purity of the final material obtained, since only desired components and non-toxic dispersion medium are used. No by-products are formed.

In WO 2006129893 mentioned above, LDH materials are obtained by classical co-precipitation. However, the materials obtained by that method need to be thoroughly purified, since it contains significant amount of alkali that has to be used in excess in order to obtain pure LDH phase. As well-known, it is impossible to make an injectable drug containing strong alkalis, such as NaOH or NH₄OH. By contrast, the present invention resolves also that problem.

In the following, the invention will be examined in more closely with the aid of a detailed description of preferred embodiments and illustrated with some working examples.

### BRIEF DESCRIPTION OF THE DRAWINGS

FIG. 1 shows the Powder XRD of the LDH reconstitution (reference system) and

FIG. 2 shows the particle size distribution of exfoliated LDH according to Examples 2.1 to 3.2.

### DESCRIPTION OF PREFERRED EMBODIMENTS

For the purpose of the present invention, the following definitions are used:

An “acid” (often represented by the generic formula HA or [H⁺ A⁻]) is considered any chemical compound that is capable of donating a hydrogen ion or proton (H⁺) to another compound (called a base, a proton acceptor).

“Nanoparticle” is a three-dimensional particle whose smallest dimension lies in the nanometer range, i.e. each one of its three dimensions is less than about 1 μm (10⁻⁶ m or 1000 nm) and at least one of those is less than 200 nm.

“Uniform” material is a material consistent in composition, despite the fact that particular atoms enter the formula with fraction coefficients. Within each particular nanoparticle the material presents practically unvaried composition and almost the same appearance of the particles. The above is due to bottom-up assembling of the material (chemical synthesis from molecules) in contrary to top-down approach widely used in the art for preparation of nanosized natural clays (for example milling, grinding, sieving or screening or a combination thereof).

Top-down approach inevitably conserves local inhomogeneities of the bulk mineral (material) and transfers it into the nano-scale: particles will have different composition, and consequently, may vary also in structure.

“Dispersion medium I” is applied at sonication step is a hydrophilic moderately polar non-complexing non-toxic biocompatible organic liquid. According to one embodiment, the liquid is a moderately polar non-complexing non-toxic biocompatible organic liquid having a viscosity in the range of 50-1500 cP (at room temperature). According to another embodiment the liquid is a moderately polar, non-complexing, moderately viscous (50-1500 cP at r.t.) dispersion medium that does not contain Cl, Br, I, S, Se, Te, N, P, As, and Si heteroatoms. According to a third embodiment, the liquid is a moderately polar (dipole moment values of 1.70-2.70 D in neat liquids, room temperature) non-complexing, non-toxic biocompatible organic liquid.

All mentioned requirements are fulfilled only for several polyols and their ethers, preferably glycerol, liquid polyethylene glycols (PEGs), and diacetin.

“Pharmaceutically active acid”, or “P.a.c.”, is any chemical compound that can be classified as a Brønsted-Lowry acid and is “intended to affect the structure or any function of the body of man or other animals” as well as “for use in the diagnosis, cure, mitigation, treatment, or prevention of disease in man or other animals”. Pharmaceutical activity of the P.a.c.'s is confirmed by including those in the Pharmacopoeia (here the Pharmacopoeia means the USP, European Pharmacopoeia, and National Pharmacopoeias or other similar Acts of National drug regulatory authorities in the countries of the patent's validity).

“Nutraceutical” is any substance that is a food, a part of a food, or dietary supplement and provides medical or health benefits.

“Biocompatible” stands for the property of not exhibiting toxic or other injurious effects on a biological system of interest.

The present invention relates to readily available synthetic anionic clays layered double hydroxides of several di- and trivalent metals, which are obtained as perfectly calibrated particles of controlled size and uniform composition throughout the material. Therefore, the embodiments of the invention are characterised by excellent reproducibility, whereas results obtained with different clay minerals depend much upon their place of origin, conditioning and grinding technologies.

By the present invention, a versatile method is provided for obtaining nanosized LDH. The novel LDHs can be used e.g. for providing inorgano-bioorganic nanocomposite materials. Intrinsically positively charged inorganic components (LDH) can be combined with any kind of natural polysaccharides and their derivatives (independently of cationic, neutral or anionic nature). Naturally various other classes of molecules can be combined with the LDHs, for example DNA, lipids, vitamins and proteins.

The invention is realised on the basis of the LDH “memory effect”. Structural reconstitution occurs in situ together with a nanocomposite formation. This chemical reaction proceeds using a normally grinded calcined LDH precursor, i.e. no special particle size reducing treatments are needed.

The novel method developed for obtaining of highly functional nano-scaled LDHs through reagent-free exfoliation (also called delamination) procedure, provides for stable nanodispersions or gels without chemical modification of the LDH precursor by using surfactant or other bulky ions that partially block the active centres of the materials and reducing their effective surface and functional properties.

As discussed above, the present invention involves modification of the initial bulk LDH material with tong-chain surfactant, zwitterionic, or other voluminous organic anions, followed by delamination in highly polar complexing organic media.

In practice, a dehydrated and decarbonated layered double hydroxide is first dispersed in a moderately polar organic dispersion medium to form a suspension. The layered double hydroxide is then reconstituted by addition of water or aqueous solution containing required anions to the suspension. The reconstitution is allowed to proceed for a sufficiently long period of time under non-boiling conditions of the medium to allow the formation of particles of a uniform nanosized layered double hydroxide material.

Preferably, the suspension of the layered double hydroxide in the dispersion medium is allowed to reconstitute with water or aqueous solution of required anions for 20-30 min under sonication conditions, and subsequently under mixing at non-boiling conditions for at least 1 hour up to 72 hours, typically for 2 to 48 hours, such as “overnight”, which stands for 4 to 12 hours.

The embodiments of the present invention are advantageous since neither modification nor complexing solvents are needed. The invention provides simple reagent-free methodology of the LDH exfoliation giving rise to a material in the most reactive “native” hydroxide form that could be readily modified upon necessity.

In one preferred embodiment, the layered double hydroxide is thermally dehydrated and decarbonized before it is being reconstituted. Thus, the layered double hydroxide can be calcined for example at a temperature of about 250 to 450° C., preferably at 400 to 430° C., for 1 to 24 hours to dehydrate and decarbonise the layered double hydroxide.

The calcined layered double hydroxide is dispersed in an organic dispersion medium by any method known per se. Sonication is considered a particular efficient way of dispersing the starting material.

In a preferred embodiment, the calcined layered double hydroxide is dispersed by sonication in an organic dispersion medium in a w/v ration of 1:3 to 1:15.

The organic dispersion medium is selected from the group of moderately polar non-complexing non-toxic biocompatible organic liquids. Definitions of such liquids were give above. Examples of suitable liquids include polyols and their ethers, preferably glycerol, liquid polyethylene glycols (PEGs), and diacetin.

The suspension of the calcined layered double hydroxide is reconstituted by addition of water or aqueous solution containing required anions in a volume ratio of 1:10 to 1:30. The aqueous solution can dilute (standing for a concentration of anions well below saturation point). The dilute aqueous solution of said anions can for example be selected from the group of OH⁻, CO₃²⁻, CH₃COO⁻, Cl⁻, NO₃⁻ and fully or partially deprotonated moieties of Brønsted-Lowry acids, particularly, metal containing inorganic anions, isopolyacids, heteropolyacids, nutraceuticals, or pharmaceutically active acids although the list is by no means exhaustive.

The nanosized layered double hydroxide material can be utilized in situ, in the reaction mixture into which it is formed, or it can be recovered from the suspension.

The uniform nanosized layered double hydroxide material can be further purified from the remaining dispersion medium by repeated washing with deionised or otherwise purified water and subsequent centrifugation.

The technologies described above in the known art are based on exfoliation of bulk LDHs by substitution of small interlayer anions with voluminous ones followed by treatment in organic solvent. However, those procedures were not able to guarantee stability of the exfoliated material. The embodiments of the present invention have an advantage of atom-efficient and reagent free process. The use of smart dispersion media (such as the PEGs, glycerol and their ethers discussed above) for calcined LDH materials gives rise to nanoshaped particles of a desired composition, moreover it provides their stabilisation. The dispersant are not complexing agents and can be easily washed out from the functional composites obtained from the LDH.

The nanoparticles of the uniform layered double hydroxide material recovered have an average size of less than 1 um, typically it is in the range of 50 to 950 nm, in particular about 100 to 900 nm, preferably about 150 to 850, often about 200 to 800 nm.

Synthetic anionic clays—layered double hydroxides may be obtained exclusively from biocompatible elements, thus achieving full biocompatibility and tailorable biodegradability of the material. All dispersion media applied in the present invention are absolutely harmless and approved by the FDA as materials suitable for direct use in humans and animals.

Therefore, all embodiments of the present invention provide easily accessible nanosized materials that could be directly used in contact with animal and human body (drug, drug delivery, dietary additive, tissue engineering, cosmetics, etc), as well as for a variety of other applications, always being environmentally friendly, fully environmentally degradable materials.

The target nanoparticles are obtained by a rehydration or “memory effect” procedure from nanoshaped calcined LDHs prepared in a suitable dispersion medium from that may be stored for practically unlimited time.

Hence, the present technology differs from the existing ones by the following criteria:
1) by absence of any reagent treatment;
2) by preparation of the nanosized LDH materials in the most reactive form or any other required form without loss of the reactivity and valuable surface properties;
3) by using exclusively biocompatible, non-toxic, and harmless dispersion media;
4) it is by-product free;
5) it is inexpensive (no need of special equipment, difficult purification steps, no reagents)
6) possibility to finely tune the final material at the nano-level by target-driven choice of the reaction conditions

The novel uniform nanosized layered double hydroxide material obtainable by the above mentioned method of the present invention has the general formula I:

[M²⁺₁₋ₓM³⁺ₓ(OH)₂][Aⁿ⁻_{z/n}.zH₂O] I
wherein
   M²⁺ is selected from Mg²⁺, Ca²⁺, Mn²⁺, Fe²⁺, Co²⁺, Ni²⁺, and Zn²⁺
   M³⁺ is selected from Al³⁺, V³⁺, Cr³⁺, Fe³⁺, Co³⁺, Sc³⁺, Ga³⁺, and Y³⁺,
   Aⁿ⁻ stands for an anion,
   x stands for a value in the range from 0.2 to 0.33,
   n is an integer from 1 to 4 and
   z is an integer from 1 to 10.

Typically, M²⁺ is selected from the group consisting of the bivalent ions of earth alkaline metals, such as Mg²⁺ and Ca²⁺ as well as transition metals, such as Zn²⁺. A suitable trivalent metal ion, M³⁺, is represented by Al³⁺. These ions will assist in rendering the material biocompatible and biodegradable.

The layered double hydroxide hosts interlayer anions to balance a charge of the hydroxide layers. The former can be selected for example from the group of OH⁻, CO₃²⁻, CH₃COO⁻, Cl⁻ and fully or partially deprotonated moieties of Brønsted-Lowry acids, particularly, nutraceuticals, or pharmaceutically active acids.

Examples of nutraceuticals and pharmaceutically active acids are, e.g., phosphoric acids, lactic acid, citric acid, derivatives of salicylic and propionic acids, etc. Naturally, also pharmaceutically acceptable acids can be used for the purpose of forming acid addition salts. Such acid include in addition to the foregoing acids also other organic acids, such as acetic acid, propionic acid, glycolic acid, oxalic acid, malonic acid, succinic acid, fumaric acid, benzoic acid, cinnamic acid, methane sulphonic acid, p-toluene sulphonic acid and salicylic acid, and inorganic acids, such as hydrochloric acid, hydrobromic acid and sulphuric acid.

Nanocomposites prepared from the novel LDHs can have an LDH concentration which varies in broad ranges from about 0.1 to 999% by weight (calculated from the weight of the second or further components), depending on the further component(s). Typically the concentration of the LDH component is in the range of about 5 to 90% w/w, a low concentration (about 5 to 40% w/w) or a high concentration (about 50-80% w/w) being preferred depending on the particular applications.

There are a number of important uses for the present novel products. Thus LDHs can be applied in heterogeneous catalysis in organic chemistry and petrochemistry, magnetic materials (precursors for magnetic spinels), pharmacy, electrode materials, tissue engineering, cosmetics, dietary supplements, etc.

In the area of catalysis the present LDHs can be used for reactions of Michaelis addition, transesterification, selective oxidation of primary alcohols, selective oxidation of secondary and tertiary amines, fixation of CO₂ to organic carbonates, epoxidation, etc. Synthetic anionic clays are used as precursors for the development of catalysts for oxidative dehydrogenation and ammoxidation of propane.

Novel magnetic materials (magnetic spinets) can also be obtained by sintering of the LDH precursors, since those materials possess more uniform distribution of constituent elements. Additionally, the present material's structure and properties may be finely tuned through ion exchange treatment of the initial LDH precursor material with anions containing doping elements.

In the pharmaceutical area, individual ingredients the LDHs are known, e.g. as tablet form excipients, active compounds in antacid formulations, and dietary additives. Nanosized form of the materials would be particularly suitable for the development of gel formulations to treat infants and serious patients. Stable nanoscaled particles would be particularly suitable for the development of different nanocomposite formulations owing to the high active surface area, better miscibility with different organic and polymeric ingredients, improved buffer and UV-shielding properties.

New valuable properties of the LDHs under the present invention, which originate from their nano-scaled structure and gel form stability, would represent a further interest for cosmetic industry. Particularly, the LDH application areas are based on their pore-constringing effect, drying and healing properties, and may include creams and gels for purification of skin, cleansing and anti-acnegenic formulations; masks for different types of skin, e.g. both for mixed-oily and tired, fragile, and sensitive skin; for exfoliation formulations, etc.

The nanosized LDH may be also of further interest for the development of membranes for fuel cell applications, sensor devices, and polyfunctional adsorbents for water treatment, etc.

The following examples are given to illustrate the invention, and should not to be considered as limiting its scope.

### EXAMPLES

Mg—Al layered double hydroxide (Mg—Al LDH) of the formula Mg_{0,67}Al_{0,33}(OH)₂(CO₃)_{0,165}×0.4 H₂O was obtained according to classic procedures, known from the prior art (e.g. U. Costantino, F. Marmottini, M. Nocchetti, R. Vivani, Eur. J. Inorg, Chem. 1998, 1439) and calcined at 430° C. for 12 h to obtain a mixture of metal oxides (further referred to as cLDH), which was cooled in vacuo, grinded to eliminate bulk lumps and stored in an argon filled dry-box.

Ultra high purity freshly deionised water has been used throughout the experiments. All manipulations were carried out under CO₂-free atmosphere.

Particle size measurements were performed by dynamic light scattering on a Zetasizer Nano (Malvern Instruments) using 1% solutions of re-suspended gels in water in a 1 cm PS cuvettes. X-ray powder diffractograms were recorded at PANalytical X'Pert Pro instrument using Cu-Kα radiation.

### Example 1

### Reference System

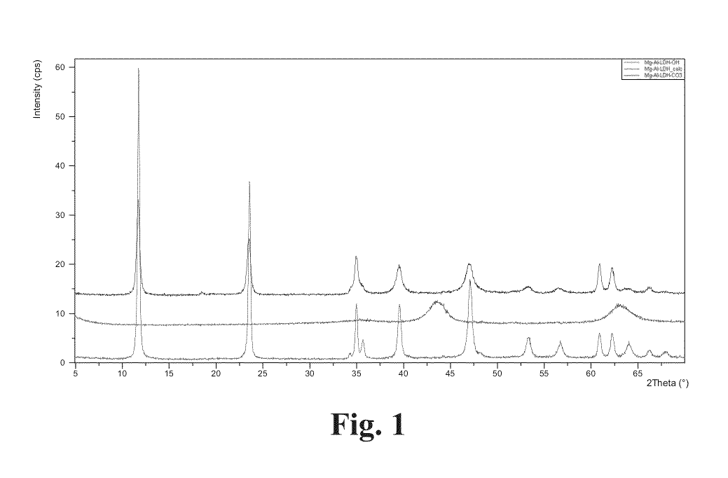

An accurately weighed amount of approximately 0.2 g of cLDH was placed into 25 ml flask inside the dry-box. 10 ml of water were added and the content was sonicated for 5-15 min. Water bath was used during sonication to maintain room temperature of the sample. The resulting suspension was poured into a bigger flask and brought to the volume of 50 ml with water. The suspension was stirred at 300-500 rpm overnight and left to sediment for 1 h. The suspension sediments almost completely, leaving trace amounts of the LDH in an aqueous phase. The results are shown on the FIG. 1.

### Example 2

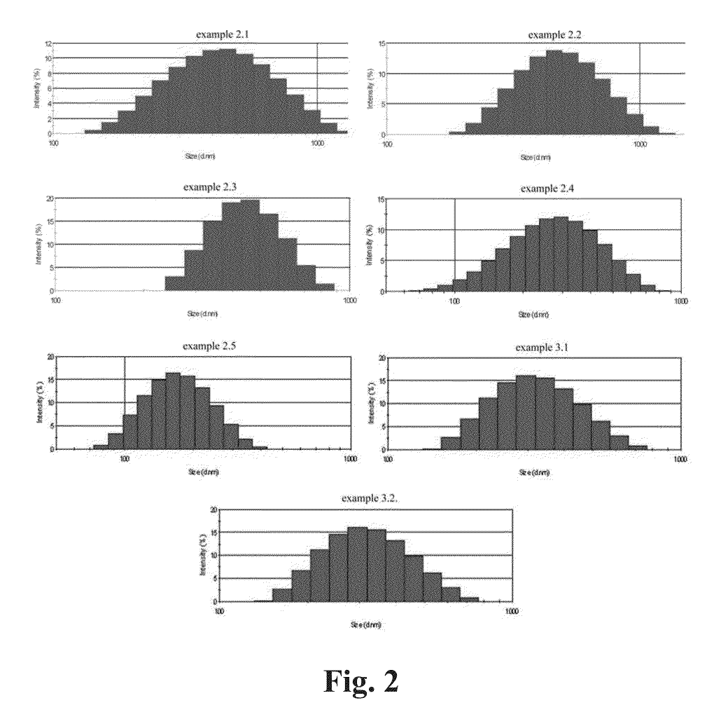

An accurately weighed amount of approximately 0.2 g of cLDH was placed into 25 ml flask inside the dry-box. 15 ml of the dispersion medium I were added and the content was sonicated for 5-15 min. Water bath was used during sonication to maintain room temperature of the sample. The resulting suspension was poured into a bigger flask and brought to the volume of 50 ml with water. The suspension was stirred at 300-500 rpm overnight and traces of non-dispersed particles were allowed to sediment for 24 h. Compositions of the dispersion medium I and results are shown in the Table 1 and FIG. 2.

### Example 3

The exfoliation may also be realised as described above in Example 2, by modification of the dispersion media (I or II). In the former case it is realised by addition of non-complexing non-toxic (biocompatible if required) non-ionic surfactant to the dispersion medium I (see Example 3.1). The latter is realised via addition of selected anions to the dispersion medium II (see Example 32). Compositions of the dispersion media and results are shown in the Table 1 and FIG. 2.

TABLE
Dispersion media composition and mean exfoliated LDH particle size

| | | Dispersion | |
|---|---|---|---|
| | Dispersion medium I | medium II | Mean particle |
| Example | (sonication) | (stirring) | size, nm |
| 1 | H₂O | H₂O | n/a (sediments) |
| 2.1 | PEG200-Glycerol (1:1) | H₂O | 186 |
| 2.2 | Glycerol | H₂O | 195 |
| 2.3 | Diacetin | H₂O | 240 |
| 2.4 | PEG400 | H₂O | 130 |
| 2.5 | PEG200 | H₂O | 60 |
| 3.1 | PEG200 + Sucrose stearate | H₂O | 113 |
| 3.2 | PEG200 | H₂O + HLLA | 98 |

1. A method of preparing a uniform nanosized layered double hydroxide material, said method comprising the steps of;
dispersing a dehydrated and decarbonated layered double hydroxide in a moderately polar organic dispersion medium to form a suspension,
reconstructing the layered double hydroxide by adding water or aqueous solution containing required anions to the suspension, and
allowing the reconstitution to proceed for a sufficient period of time at non-boiling conditions of the medium to afford the formation of particles of a uniform nanosized layered double hydroxide material.

2. The method according to claim 1, wherein the nanosized layered double hydroxide material is recovered from the suspension.

3. The method according to claim 1, wherein the layered double hydroxide is thermally dehydrated and decarbonized before it is being reconstituted.

4. The method according to claim 3, wherein the layered double hydroxide is calcined at a temperature between 250 to 450° C., for 1 to 24 hours to dehydrate and decarbonise the layered double hydroxide.

5. The method according to claim 4, wherein the calcined layered double hydroxide is dispersed in an organic dispersion medium by means of sonication.

6. The method according to claim 1, wherein the calcined layered double hydroxide is dispersed by sonication in an organic dispersion medium in a w/v ration of 1:3 to 1:15.

7. The method according to claim 1, wherein the suspension of the calcined layered double hydroxide is reconstituted by addition of water or aqueous solution containing required anions in a volume ratio of 1:10 to 1:30.

8. The method according to claim 7, wherein the dilute aqueous solution of said anions is selected from the group of OH⁻, CO₃²⁻, CH₃COO⁻, Cl⁻, NO₃⁻ and fully or partially deprotonated moieties of Brønsted-Lowry acids, particularly, metal containing inorganic anions, isopolyacids, heteropolyacids, nutraceuticals, or pharmaceutically active acids.

9. The method according to claim 1, wherein the uniform nanosized layered double hydroxide material is further purified from the remaining dispersion medium by repeated washing with deionised or otherwise purified water and subsequent centrifugation.

10. The method according to claim 1 comprising recovering the nanoparticles of uniform layered double hydroxide material, said particles having an average size in the range of 50 to 950 nm.

11. The method according to claim 1, wherein the suspension of the layered double hydroxide in the dispersion medium is allowed to reconstitute with water or aqueous solution of required anions for 20-30 min under sonication conditions, and subsequently under mixing at non-boiling conditions overnight.

12. The method according to claim 1, wherein the hydrophilic moderately polar non-complexing non-toxic biocompatible organic liquid has a viscosity in the range of 50-1500 cP (at room temperature).

13. The method according to claim 1, wherein the hydrophilic moderately polar non-complexing non-toxic biocompatible organic liquid does not contain heteroatoms selected from the group of Cl, Br, I, S, Se, Te, N, P, As, and Si.

14. The method according to claim 1, wherein the biocompatible organic liquid has a dipole moment value in the range of 1.70 to 2.70 D in neat liquids, room temperature.

15. The method according to claim 1, wherein the organic dispersion medium is selected from the group of moderately polar non-complexing non-toxic biocompatible organic liquids, in particular polyols and their ethers, preferably glycerol, liquid polyethylene glycols (PEGs), and diacetin.

16. A uniform nanosized layered double hydroxide material having the general formula I
[M²⁺₁₋ₓM³⁺ₓ(OH)₂][Aⁿ⁻_{x/n}.zH₂O] I
wherein
M²⁺ is selected from Mg²⁺, Ca²⁺, Mn²⁺, Fe²⁺, Co²⁺, Ni²⁺, and Zn²⁺
M³⁺ is selected from Al³⁺, V³⁺, Cr³⁺, Fe³⁺, Co³⁺, Sc³⁺, Ga³⁺, and Y³⁺,
Aⁿ⁻ stands for an anion,
x stands for a value in the range from 0.2 to 0.33,
n is an integer from 1 to 4 and
z is an integer from 1 to 10.
having an average particle size of less than 1 μm.

17. The material according to claim 16, wherein the M²⁺ is selected from Mg²⁺, Ca²⁺, Zn²⁺, and M³⁺═Al³⁺ in order to render biocompatibility and biodegradability to the material.

18. The material according to claim 16, wherein the layered double hydroxide exhibits anions selected from the group of OH⁻, CO₃²⁻, CH₃COO⁻, Cl⁻, NO₃⁻ and fully or partially deprotonated moieties of Brønsted-Lowry acids, particularly, metal containing inorganic anions, isopolyacids, heteropolyacids, nutraceuticals, or pharmaceutically active acids.

19. The material according to claim 16, wherein the particles have an average particle size in the range of 50 to 950 nm.

20. (canceled)

21. (canceled)

22. (canceled)

23. (canceled)

24. (canceled)

25. (canceled)

26. (canceled)

27. (canceled)

28. (canceled)

29. (canceled)

30. (canceled)
